(19) United States
(12) Patent Application Publication
(10) Pub. No.: US 2016/0379226 A1
(43) Pub. Date: Dec. 29, 2016

(54) INTELLIGENT IDENTIFICATION OF MULTIDIMENSIONAL INSIGHTS FROM PROCESS DATA

(71) Applicant: Microsoft Technology Licensing, LLC, Redmond, WA (US)

(72) Inventors: Yoav Mayer-wolf, Tel Aviv (IL); Raanan Zvi, Qiryat Bialik (IL); Adi Ben Dayan, Tel Aviv (IL); Yoav Yassour, Zichron-Yaakov (IL); Aviv Ezrachi, Binyamina (IL)

(73) Assignee: Microsoft Technology Licensing, LLC

(21) Appl. No.: 14/750,659

(22) Filed: Jun. 25, 2015

(51) Int. Cl. G06Q 30/02; G06F 3/0484

(52) U.S. Cl. CPC G06Q 30/0201; G06F 3/04842

(57) ABSTRACT

Technologies are described herein for providing intelligent identification of multidimensional insights from staged process data. In some configurations, the techniques described herein obtain process data defining a multistage process and attributes relating to individual stages of the process. Configurations analyze the process data to identify the attributes characterizing at least one conversion between individual stages. For example, attributes associated with users interacting with a retail site may be identified. The attributes can include any activity or characteristic such as a user's location, age, length of time on a site, etc. The attributes define classifications that provide insights into target areas. Techniques disclosed herein also involve the generation of output data defining the one or more attributes associated with at least one stage and/or conversion of the process. Graphical elements representing the attributes may be displayed in proximity to graphical representations of relevant stages of the process.

### BACKGROUND

Funnel charts are often used to represent stages in a process. Such charts are typically used for displaying a performance metric for individual stages of the process. In addition, such charts are used to show conversions between the stages of the process. This type of chart can also be useful in identifying potential problem areas in an organization's processes. For example, a marketing funnel chart can describe a customer's movement through a process, starting from a first customer contact through a transaction stage. Such funnel charts can show, for example, a particular stage where customer activity is less than optimal.

Although some existing technologies are effective in showing certain performance metrics of a process, current technologies are limited with respect to the depth of information that is provided. For instance, most programs used for generating data for a funnel chart tend to focus on a single performance metric for individual stages. The use of such data is limited when it comes to providing insights that may be used for identifying problems and solutions.

It is with respect to these and other considerations that the disclosure made herein is presented.

### SUMMARY

Technologies are described herein for providing intelligent identification of multidimensional insights from staged process data. Utilizing the technologies described herein, an analysis of process data can identify one or more attributes that are associated with a conversion rate exceeding one or more thresholds. The identified attributes can be used to define classifications that provide insights that may be used to identify problems and solutions. Output data defining the classifications provide an association between the identified attributes and relevant stages of a process.

In some configurations, a computing device obtains staged process data defining attributes relating to individual stages of a multistage process. For example, staged process data may define attributes associated with users such as a country of origin, age, gender, browsing history, etc. The techniques disclosed herein may analyze the staged process data to identify one or more attributes characterizing at least one conversion between individual stages of the process. In some configurations, the techniques disclosed herein can identify and/or select one or more attributes based on a conversion rate associated with the one or more attributes. In one illustrative example, the techniques disclosed herein may identify and/or select one or more attributes if an associated conversion rate exceeds one or more thresholds.

The identified attributes may be used to define classifications that provide insights into target areas. Techniques disclosed herein also involve the generation of output data associating the identified attributes with at least one conversion of the multistage process or at least one stage of the multistage process. Graphical elements representing the identified attributes can be displayed in proximity to graphical representations of relevant stages and/or conversions of the process. In addition, the techniques disclosed herein can generate and display graphical elements representing characteristics of user groups associated with the identified attributes.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, can refer to systems, methods, computer-readable instructions, modules, algorithms, hardware logic and/or operations as permitted by the context described above and throughout the document. Items or conditions that Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for providing intelligent identification of multidimensional insights from staged process data.

FIG. 2A illustrates an example rendering of a funnel chart that can be generated from data defining a multistage process.

FIG. 2B illustrates an example of a graphical element that may be used to display attributes of a classification associated with at least one stage of a process.

FIG. 3 is a screen diagram showing an illustrative graphical user interface that is configured to display representations of user groups based on attributes of a classification.

FIG. 4 is a flow diagram showing aspects of a routine disclosed herein for providing intelligent identification of multidimensional insights from process data.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

FIG. 7 is a computer architecture diagram illustrating a computing device architecture for a computing device capable of implementing aspects of the techniques and technologies presented herein.

### DETAILED DESCRIPTION

Technologies are described herein for providing intelligent identification of multidimensional insights from process data. In some configurations, the process data may include staged process data. Utilizing the technologies described herein, an analysis of process data can identify one or more attributes that are associated with a conversion rate exceeding one or more thresholds. The identified attributes may be used to define classifications that provide insights that may be used to identify problems and solutions. Output data defining the classifications provide an association between the identified attributes and relevant stages of a process.

In some configurations, a computing device obtains process data defining attributes relating to individual stages of a multistage process. For example, process data may define attributes associated with users such as a country of origin, age, gender, browsing history, etc. The techniques disclosed herein may analyze the process data to identify one or more attributes characterizing at least one conversion between individual stages of the process. In some configurations, the techniques disclosed herein can identify and/or select one or more attributes based on a conversion rate associated with the one or more attributes. As will be described in the examples noted herein, the techniques disclosed herein may identify and/or select one or more attributes if an associated conversion rate exceeds one or more thresholds.

The identified attributes may be used to define classifications that provide insights into target areas. Techniques disclosed herein also involve the generation of output data associating the identified attributes with at least one conversion of the multistage process or at least one stage of the multistage process. Graphical elements representing the identified attributes can be displayed in proximity to graphical representations of relevant stages and/or conversions of the process. In addition, the techniques disclosed herein can generate graphical elements representing characteristics of user groups associated with the identified attributes.

It should be appreciated that the above-described subject matter may be implemented as a computer-controlled apparatus, a computer process, a computing system, or as an article of manufacture such as a computer-readable storage medium. Among many other benefits, the techniques herein improve efficiencies with respect to a wide range of computing resources. For instance, human interaction with a device may be improved as the use of the techniques disclosed herein enable efficient interpretation of data. Improved human interaction with the device may mitigate issues related to inadvertent inputs or other errors. In addition, improved human interaction improves other computing resources such as processor and network resources.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

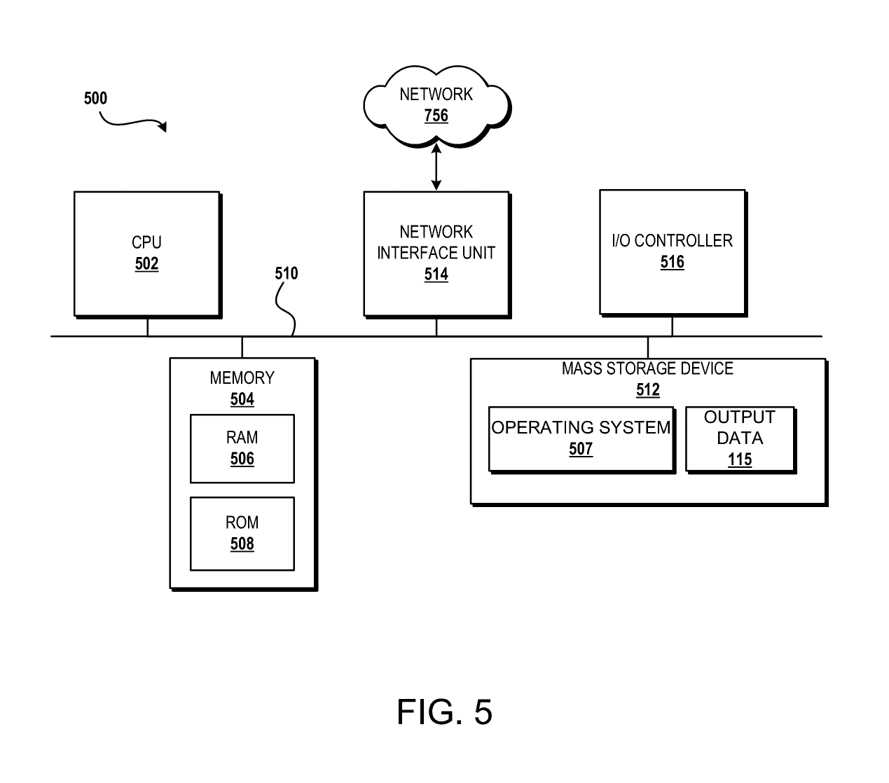

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing intelligent identification of multidimensional insights from process data. As will be described in more detail below with respect to FIGS. 5-7, there are a number of applications and services that can embody the functionality and techniques described herein.

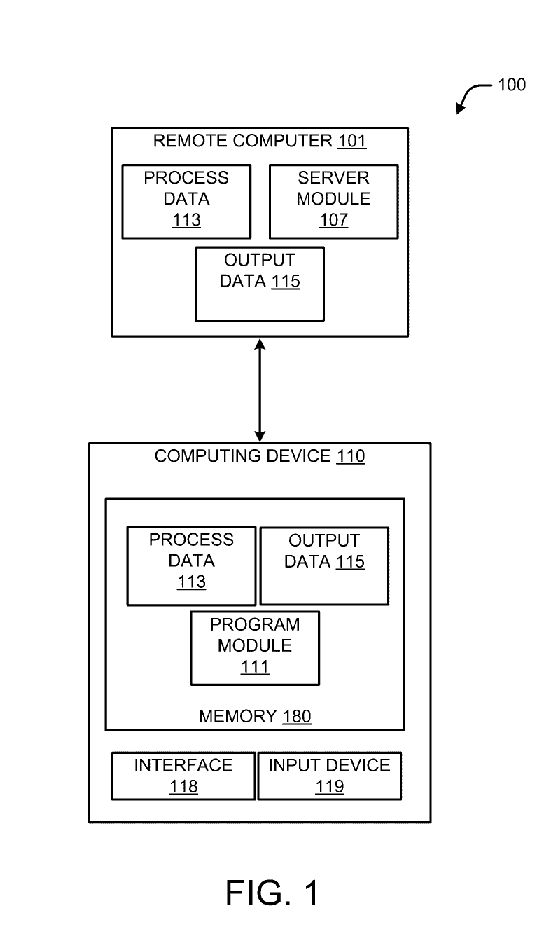

FIG. 1 is a system diagram showing aspects of one illustrative mechanism disclosed herein for providing intelligent identification of multidimensional insights from process data. As shown in FIG. 1, a system 100 may include a remote computer 101 and a computing device 110. The computing device 110 may operate as a stand-alone device, or the computing device 110 may operate in conjunction with the remote computer 101. As can be appreciated, the remote computer 101 and the computing device 110 are interconnected through one or more local and/or wide area networks (not shown). It should be appreciated that this example is provided for illustrative purposes only and is not to be construed as limiting. The techniques described herein may utilize more or fewer computers than those shown in FIG. 1.

The computing device 110 may be in the form of a personal computer, a mobile phone, or any other device having components for processing and communicating process-related data. For example, the computing device 110 may be a personal computer having an interface 118 and at least one input device 119. Data displayed on the interface 118, such as a monitor, projection surface, touch screen, or any other device, allows a user to interact with the computing device 110. In addition, by the use of at least one input device 119, such as a camera, microphone, keyboard or any other device, a user may provide process data 113.

The computing device 110 may include a local memory 180 that is capable of storing, communicating, and processing process data 113, output data 115, and other data. The local memory 180 may also include a program module 111 configured to manage techniques described herein and interactions between a user and the computing device 110. The program module 111 may be a productivity application, a customer relationship management (“CRM”) application, an operating system component or any other application configured to process data.

The remote computer 101 may be in the form of a personal computer, server computer or a number of server computers configured to store and process data. As can be appreciated, the remote computer 101 may be configured to communicate, process and store the process data 113, output data 115, and other data. The remote computer 101 may also include components such as the server module 107, for executing one or more techniques described herein. The server module 107 may operate in conjunction with, or independent of, other modules, such as the program module 111, to implement aspects of the techniques disclosed herein.

In one illustrative example, during operation, the computing device 110 may obtain process data 113. The process data 113 may be from any suitable resource, such as a CRM program, another computer, or a user input. In addition, the process data 113 may be in any suitable format. In some configurations, the process data 113 may include attributes associated with user data and activity of a service or platform. The process data 113 may also include attributes associated with individual stages of a multistage process. For example, the attributes may include details describing a user's country of origin, age, gender, browsing history, browser type, the length of time spent on the site, etc. The attributes may also describe a user's activity at individual stages of a multistage process. These examples are provided for illustrative purposes and are not to be construed as limiting.

In some configurations, the process data 113 may include data defining a multistage process. As will be described in more detail below, data defining a multistage process may include a description of individual stages of the process. For instance, a first stage may be associated with a goal or an activity, such as users accessing a first page of a web site. In such an example, a second stage may be associated with goals or activities such as a selection of a link on the web site. Subsequent stages may be associated with actions such as a sales transaction or other tasks or actions. Such examples are provided for illustrative purposes and are not to be construed as limiting.

As summarized above, the techniques disclosed herein may identify one or more attributes that may be used to define one or more classifications. In some configurations, the identification of the attributes may be based on an associated conversion rate. In some configurations, the identification of the attributes may be based on an associated conversion rate that exceeds one or more thresholds. For illustrative purposes, an “attribute combination” or a “combination of attributes” includes one or more attributes.

In order to provide the functionality summarized above, the program module 111 processes and analyzes various attribute combinations obtained from input data, e.g., process data 113. In one illustrative example, the techniques disclosed herein may select a combination of attributes based on an associated conversion rate. Such configurations may involve the identification and selection of attribute combinations associated with high and/or low conversion rates. In addition, such configurations may involve the identification and selection of attribute combinations associated conversion rates exceeding one or more thresholds.

In some configurations, an individual dataset defining an attribute combination may be ranked based on an associated conversion rate. Individual datasets defining attribute combinations can be identified and selected based on the ranking and or an associated conversion rate. In some configurations, an individual dataset defining a combination of attributes may be selected if an associated ranking and/or a conversion rate surpasses one or more thresholds. By the use of such techniques, one or more attributes are identified through mechanisms that determine which attribute combination a user may be most interested in.

For illustrative purposes, the one or more thresholds may be determined by a user input and/or by other techniques. For instance, in one example, a number of conversion rates for a number of attribute combinations may be determined. An average conversion rate may be determined from the calculated conversion rates. Then, one or more thresholds may be determined based on the average or another determined value. For example, a threshold may be one or two standard deviations from the average or mean conversion rate. These examples are provided for illustrative purposes and are not to be construed as limiting. It can be appreciated that the techniques disclosed herein may utilize number of suitable technologies for determining one or more thresholds and/or selecting attribute combinations based on the process data 113, input data, other contextual data, and/or conversion rates.

To illustrate aspects of the disclosed concepts, consider the sample dataset shown in TABLE 1.

TABLE 1

| | | | Browser | | | |
|---|---|---|---|---|---|---|
| Country | Time on Site | User Type | Type | Stage 1 | Stage 2 | Stage 3 |
| UK | 5.10 | Paid | IE | 9.00 | 3.60 | |
| UK | 5.10 | Free | MOZ | 1.00 | 3.60 | |
| UK | 5.10 | Free | MOZ | 9.00 | 3.40 | |
| UK | 6.20 | Free | MOZ | 1.00 | 1.30 | |
| UK | 12.00 | Free | IE | 9.00 | 2.00 | 2.10 |
| UK | 10.00 | Paid | IE | 1.00 | 2.00 | 2.12 |
| US | 5.20 | Paid | IE | 11.00 | | |
| JP | 5.10 | Paid | MOZ | 18.00 | | |
| CA | 5.10 | Paid | IE | 11.00 | | |
| MX | 5.20 | Paid | MOZ | 12.00 | | |
| US | 5.30 | Paid | IE | 15.00 | | |

The sample data shown in TABLE 1 illustrates a portion of process data 113 defining attributes associated with a sample process. The sample data illustrates the first three stages of a multistage process. Specifically, the sample dataset of process data 113 includes a number of attributes: country of origin, time on the web site (minutes), user type, browser type, time on the first stage (minutes), time on the second stage (minutes), and time on the third stage (minutes).

As described above, one or more attributes may be identified and selected depending on an associated conversion rate. In some configurations, the techniques disclosed herein may analyze a number of attribute combinations and determine an associated conversion rate for each attribute combination. In some configurations, the techniques herein may analyze any number of attribute combinations, including an exhaustive list of combinations and rank the combinations based on the associated conversion rates. One or more attribute combinations may be identified and/or selected based on the ranking and/or the associated conversion rates.

For illustrative purposes, the sample data described above is analyzed with respect to a number of performance metrics, which in the following example measures a conversion. A conversion refers to user advancement between stages of a multistage process. As summarized above, a number of combinations of attributes may be processed to determine an associated conversion rate and/or other data. As can be appreciated, any combination of attributes may be analyzed to determine an associated conversion rate for any combination of stages.

For example, techniques disclosed herein may analyze a first combination of attributes that includes a single attribute, “browser type.” In such an example, a conversion rate may be calculated for a number of conversions between various stages in the process. With reference to the data in TABLE 1, for a conversion between stage 1 and stage 2, the conversion rate associated with the first combination of attributes is fifty percent (50%) for users having the INTERNET EXPLORER (“IE”) Web browser. In addition, for a conversion between stage 2 and stage 3, the conversion rate associated with the first combination of attributes is thirty-three percent (33%) for users having an IE browser.

In continuing the above example, techniques disclosed herein may analyze a second combination of attributes, e.g., an attribute such as the “country of origin.” With reference to the sample data of TABLE 1, for a conversion between stage 1 and stage 2, the conversion rate associated with the second combination of attributes is fifty percent (50%) for users from the UK.

In continuing the above example, techniques disclosed herein may analyze a third combination of attributes. In this example, the third combination of attributes includes a combination of attributes: “time on site” and the “country of origin.” With reference to the data in TABLE 1, for a conversion between stage 1 and stage 2, the conversion rate associated with the third combination of attributes is thirty three percent (33%) for UK users who spent more than 6 minutes on the site. In addition, for a conversion between stage 2 and stage 3, the conversion rate associated with the third combination of attributes is sixty six percent (66%) for UK users who spent more than six minutes on the site. In yet another example calculation, for a conversion between stage 1 and stage 3, the conversion rate associated with the third combination of attributes is eighteen percent (18%) for UK users who spent more than six minutes on the site.

The techniques disclosed herein analyze a number of attribute combinations and generate a conversion rate for individual attribute combinations. For example, techniques may analyze data associated with an attribute combination involving: “country of origin,” “time on site,” “user type,” and “browser type.” Another attribute combination may involve: “time on site,” “user type,” and “browser type.” In yet another example, an attribute combination may involve: “user type,” and “browser type.” The techniques disclosed herein analyze many more attribute combinations for some or all conversions of a process and/or combinations of conversions. These examples are provided for illustrative purposes and are not to be construed as limiting. It can be appreciated that some types of process data 113 may include hundreds or thousands of attributes, and potentially millions of entries.

As will be described in more detail below, the selected attribute combinations may be used to define a classification. In some configurations, the techniques disclosed herein can rank the classifications based on the determined conversion rates. In some configurations, classifications having conversion rates exceeding one or more predetermined threshold levels may be selected and displayed to a user to provide detailed insights into the process data 113.

For example, techniques described herein may select attributes relating to high conversion rates and low conversion rates, such as the top 5% of the calculated conversion rates and/or the lowest 5% of the calculated conversion rates. In another example, a threshold may be determined based on an average conversion rate and calculated standard deviation values. It can be appreciated that these examples are provided for illustrative purposes and are not to be construed as limiting as the techniques described herein may utilize many other suitable methods for identifying and selecting attribute combinations.

In applying the above-described techniques to the example data of TABLE 1, the techniques disclosed herein may select the third combination of attributes since the conversion rate for the conversion between stage 1 and stage 2 was thirty-three percent (33%) for UK users who spent more than 6 minutes on the site. In addition, the techniques disclosed herein may select the third combination of attributes since the conversion rate for the conversion between stage 2 and stage 3 was sixty-six (66%) for UK users who spent more than 6 minutes on the site. In yet another example, the techniques disclosed herein may select the third combination of attributes since the conversion rate for the conversion between stage 1 and stage 3 was eighteen percent (18%) for UK users who spent more than 6 minutes on the site.

These examples are provided for illustrative purposes and are not to be construed as limiting. Any number of suitable technologies for selecting attribute combinations based on associated conversion rates may be utilized by the techniques described herein. In some configurations, an entropy-based algorithm may be utilized.

As summarized above, techniques disclosed herein may generate output data 115 defining the selected attribute combinations. In some configurations, the output data 115 may be configured to associate the attribute combinations with at least one stage or conversion of a process. In some configurations, the output data 115 may include classifications that are defined by the selected attribute combinations. The output data 115 may also be configured to associate at least one stage or conversion with one or more insights, which may include a summary of the attribute combinations. In some configurations, output data 115 may be configured to generate a graphical representation of a process and a graphical element displaying one or more classifications and/or selected attribute combinations.

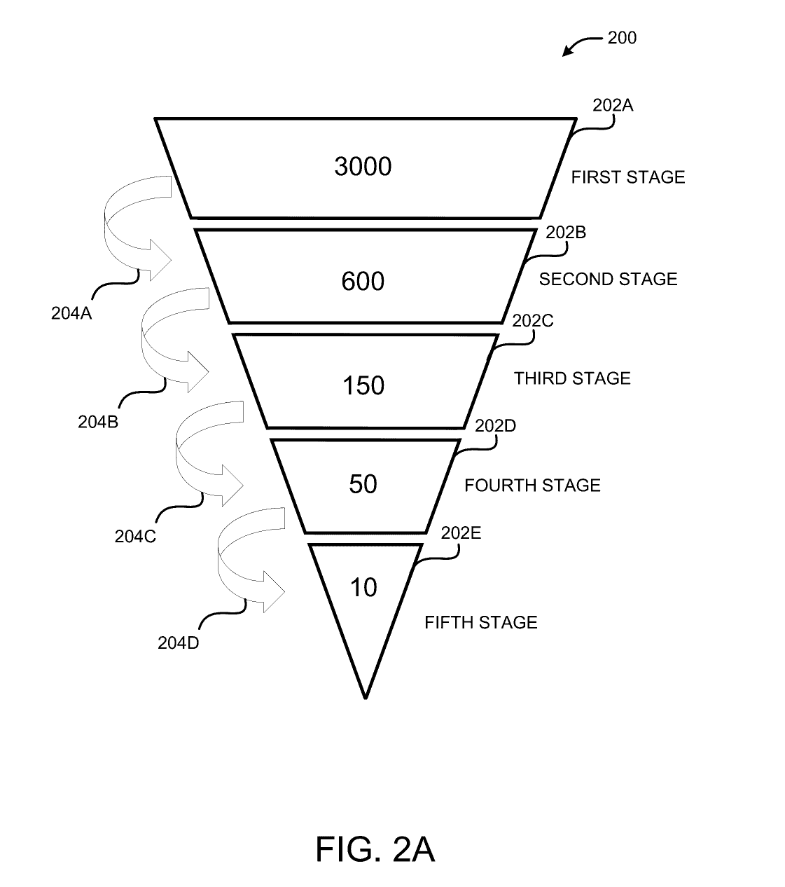

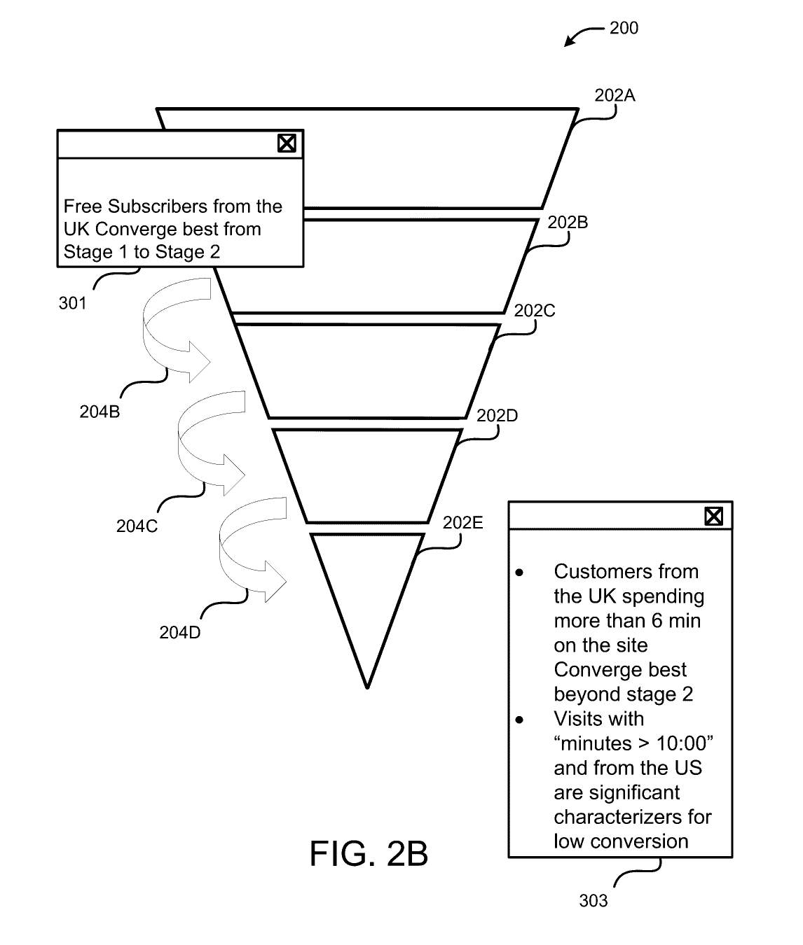

FIG. 2A illustrates an example rendering of a funnel chart 200 that can be generated from process data 113 and/or output data 115 defining a multistage process. In this illustrative example, the funnel chart 200 illustrates a representation of a process modeling user activity of a retail web site. The funnel chart 200 contains five stages (202A-202E): a first stage 202A indicating visitors to the web site, a second stage 202B related to the selection of an item, a third stage 202C related to entry of personal information, a fourth stage related to the entry of credit card information, and a fifth stage related to the close of a sale. The sample data displayed with the funnel chart 200 indicates that 3000 users visited the web site, 600 users selected an item, 150 users entered personal information, 50 users entered credit card information, and 10 users completed a transaction. Although this illustrative example shows a rendering of a process in the form of a funnel chart with five stages, can be appreciated that the rendering may include many other graphical arrangements to convey a process having any number of stages.

As summarized above, the techniques disclosed herein can generate output data 115 defining a graphical element displaying one or more selected classifications. The graphical element may include one or more classifications and/or groups of related attributes. In some configurations, the display of the graphical element can be displayed in response to a user selection. In such a configuration, the rendering of the funnel chart 200 includes a number of selectable elements (204A-204D) that are respectively associated with transitions between each stage (202A-202E). A user interface displaying the rendering of the funnel chart 200 can be configured to detect a selection of one or more selectable elements (204A-204D). In addition, the user interface displaying the rendering of the funnel chart 200 can be configured to display a graphical element showing a classification or an associated combination of attributes in response to the selection of the one or more selectable elements (204A-204D). These examples are provided for illustrative purposes only and are not to be construed as limiting. It can be appreciated that the techniques disclosed herein may include selectable elements that apply to multiple stages.

One illustrative example of a graphical element 301 is shown in FIG. 2B. In some configurations, the graphical element 301 can be displayed in response to a user selection of the first selectable element 204A. To indicate an association between a classification and at least one relevant stage, the graphical element 301 is displayed in proximity to the conversion between the first stage 202A and the second stage 202B. Such arrangements enable users to readily view and interpret salient insights that are based on one or more attributes associated with at least one stage, or a conversion between two or more stages.

Additionally or alternatively, graphical elements of one or more classifications and/or attribute combinations may be automatically selected and displayed depending on an associated conversion rate. As summarized above, techniques disclosed herein may rank a number of classifications based on an associated conversion rate. One or more of the classifications may be automatically selected based on the associated conversion rates and/or a ranking. In some configurations, the selected classifications may be automatically displayed with a rendering of a process, e.g., the funnel chart 200. As described above, classification information may be positioned and arranged in proximity to a relevant stage, stages and/or a transition between two or more stages.

The second graphical element 303 of FIG. 2B illustrates one example of a graphical element that may be used to display automatically selected classifications. In this example, the second graphical element 303 includes classifications having a summary of attributes relating to multiple stages of the funnel chart 200. The position and/or arrangement of the second graphical element 303 may indicate such relationships. Other graphical elements may be used to show an association between a classification and a stage or a conversion. For example, lines, arrows or other graphical elements may be used to associate a classification with a relevant stage or multiple stages. In the illustrative example shown in FIG. 2B, based on the sample data of TABLE 1, the second graphical element 303 indicates that “customers from the UK spending more than 6 min on the site converge best beyond stage 2” and that “visits with minutes >10:00 from the US are significant characterizers for low conversion.”

As summarized above, the techniques described herein can identify groups of users associated with the selected attribute combinations. In such configurations, in addition to analyzing, selecting and displaying different attribute combinations, the techniques disclosed herein may also generate a display illustrating another quantity, such as group size, that is based on the selected classifications and/or selected attribute combinations.

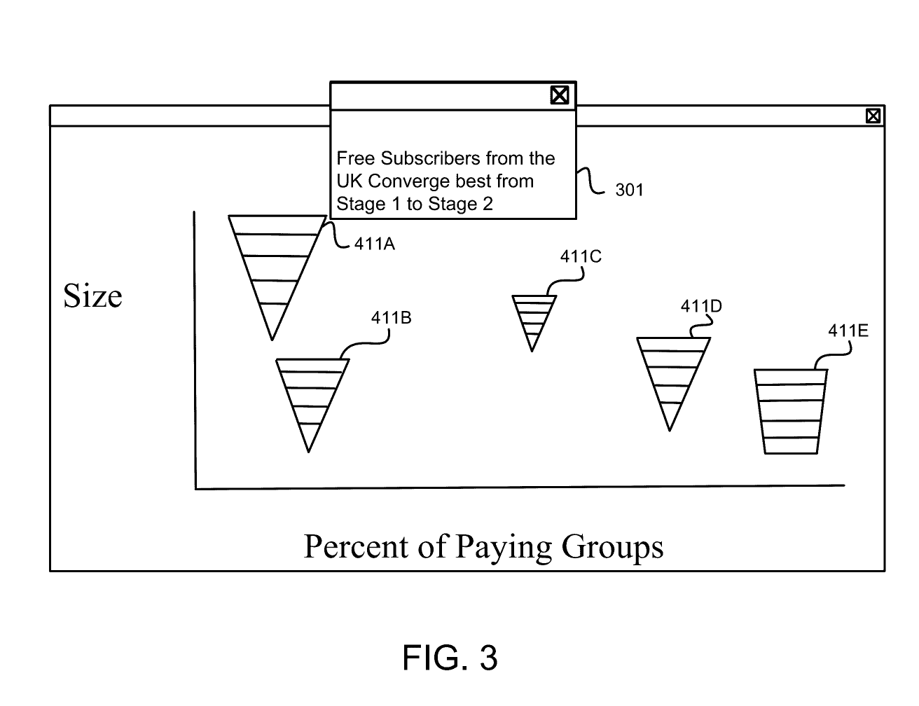

FIG. 3 illustrates a sample rendering of a chart 300 that is generated by the techniques disclosed herein. Using the techniques described herein, process data 113 can be analyzed to identify various groups of users that are associated with selected attribute combinations. For instance, some configurations may determine a number of users associated with attribute combinations having high or low conversion rates. Graphical representations of individual groups, shown as graphical elements (411A-411E), can be generated and displayed. In some configurations, the size and shape of the graphical elements (411A-411E) may be based on related attributes and/or related portions of the process data 113.

For illustrative purposes, the chart 300 is arranged to show a group size (Y-axis) with a percent of paying groups (X-axis). In such an example, the first graphical element 411A indicates that a relatively large group of users has a relatively low percent of paying users. The fifth graphical element 411E indicates that a relatively small group of users has a relatively high percent of paying users. The size and/or shape of the graphical elements (411A-411E) can be used to represent other types of data. For instance, the fifth graphical element 411E is configured with a trapezoid-shaped element, versus a triangle, to illustrate that a high percentage of users within that group of users had a high rate of conversion from the first stage to the last stage. In another example, the size of the first graphical element 411A is larger than other graphical elements (411B-411E) to graphically represent another attribute, such as the average minutes spent on a stage.

In addition, salient insights may be selected and displayed, such as those shown in the graphical element 301 of FIG. 3. The insights may be selected and displayed using the techniques described above. In some configurations, such graphical elements, such as graphical element 301, can be displayed in proximity to a relevant group. In addition, such graphical elements can be displayed in response to a user input. In yet another example, such graphical elements can be automatically selected and displayed based on a related conversion rate. These examples are provided for illustrative purposes only and are not to be construed as limiting.

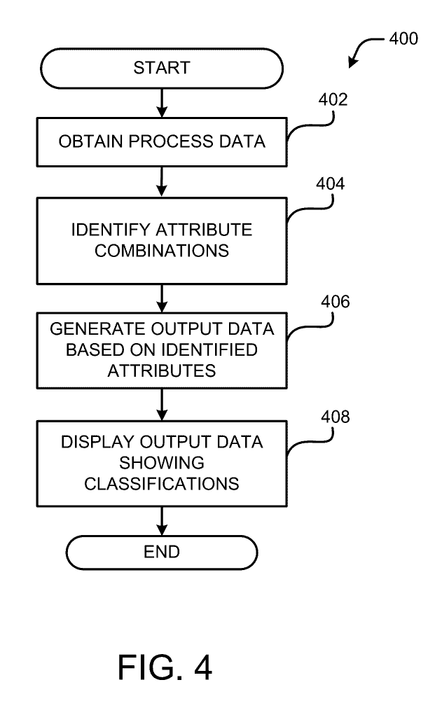

Turning now to FIG. 4, aspects of a routine 400 for providing intelligent identification of multidimensional insights from process data are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As will be described in more detail below, in conjunction with FIG. 1, the operations of the routine 400 are described herein as being implemented, at least in part, by an application, component, and/or circuit. Although the following illustration refers to the components of FIG. 1, it can be appreciated that the operations of the routine 400 may be also implemented in many other ways. For example, the routine 400 may be implemented, at least in part, by computer processor or processor of another computer. In addition, one or more of the operations of the routine 400 may alternatively or additionally be implemented, at least in part, by a computer working alone or in conjunction with other software modules, such as the server module 107.

With reference to FIG. 4, the routine 400 begins at operation 402, where the process data 113 is obtained. The process data 113 may be in any suitable format and may be from any suitable resource, such as a CRM program, another computer, or a user input. In some configurations, the process data 113 may include attributes associated with user data and user activity of a service or platform. The process data 113 may also include attributes associated with individual stages of a multistage process. For example, the attributes may include details describing a user's country of origin, age, user type, browsing history, browser type, the length of time spent on the site, etc. The attributes may also describe a user's activity at individual stages of a multistage process. In some configurations, the process data 113 may include data defining a multistage process. These examples are provided for illustrative purposes and are not to be construed as limiting.

Next, in operation 404, the program module 111 identifies attribute combinations. In some configurations, the program module 111 processes and analyzes various combinations of attributes obtained from the process data 113. Individual datasets defining attribute combinations may be ranked based on a value that is indicative of a conversion rate associated with at least one stage. Individual datasets defining attribute combinations can be identified and selected based on the ranking and/or one or more conversion rates. In some configurations, an individual dataset defining an attribute combination may be selected if an associated ranking and/or an associated conversion rate exceeds a threshold. Any suitable technology for identifying attribute combinations, including entropy-based technologies, may be utilized in operation 404.

Next, in operation 406, the program module 111 may generate output data 115 defining the classifications, e.g., the attribute combinations, associated with at least one stage of the process. In some configurations, output data 115 may be configured to generate a graphical representation of a process and a graphical element displaying one or more selected attribute combinations. In some configurations, an insight, such as a summary of selected attribute combinations may be generated and displayed with the graphical representation and/or the graphical element.

Next, in operation 410, the program module 111 may cause a display of the output data 115. Example renderings of the output data 115 are shown in FIG. 2B and FIG. 3. As shown and described above, a graphical element may be used to display selected classifications and/or selected attribute combinations. In addition, the position, size, and/or arrangement of the graphical elements may indicate relationships between the classifications and related process stages. In addition, some configurations may arrange a graphical element indicating a size of a user group associated with selected attribute combinations. After operation 410, the routine 400 terminates.

FIG. 5 shows additional details of an example computer architecture 500 for a computer, such as the computing device 101 (FIG. 1), capable of executing the program components described herein. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 507, data, such as the output data 115, and one or more application programs.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 756 and/or another network (not shown). The computer architecture 500 may connect to the network 756 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

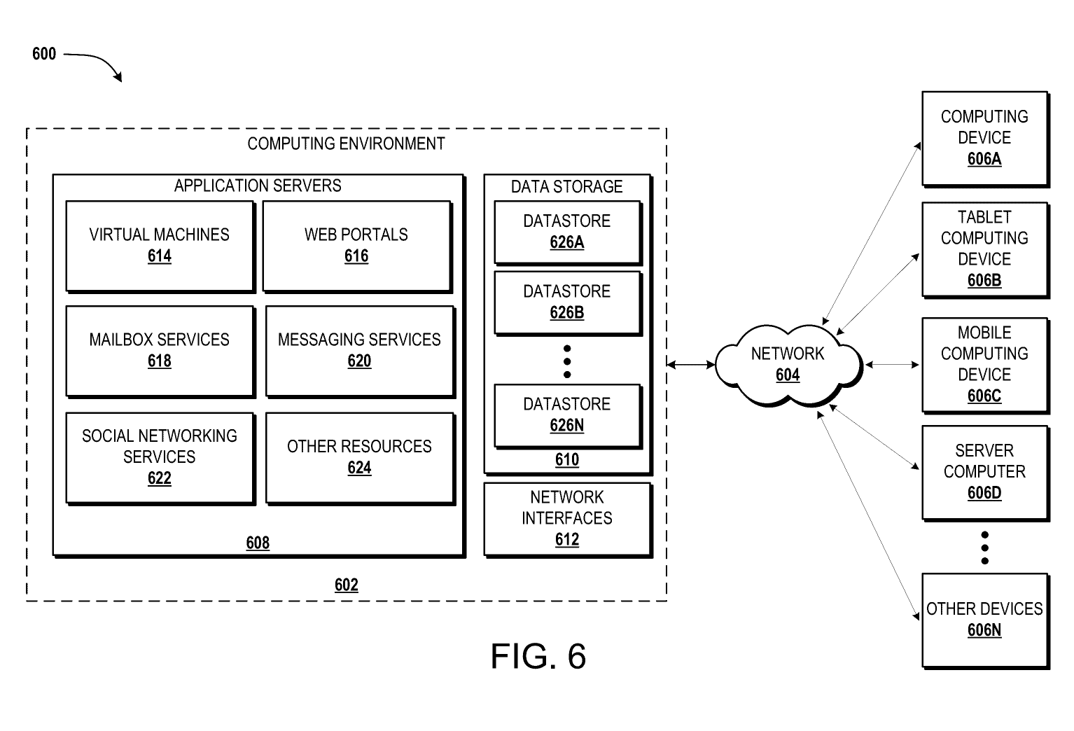

FIG. 6 depicts an illustrative distributed computing environment 600 capable of executing the software components described herein for providing intelligent identification of multidimensional insights from process data. Thus, the distributed computing environment 600 illustrated in FIG. 6 can be utilized to execute any aspects of the software components presented herein. For example, the distributed computing environment 600 can be utilized to execute aspects of the web browser 510, the content manager 105 and/or other software components described herein.

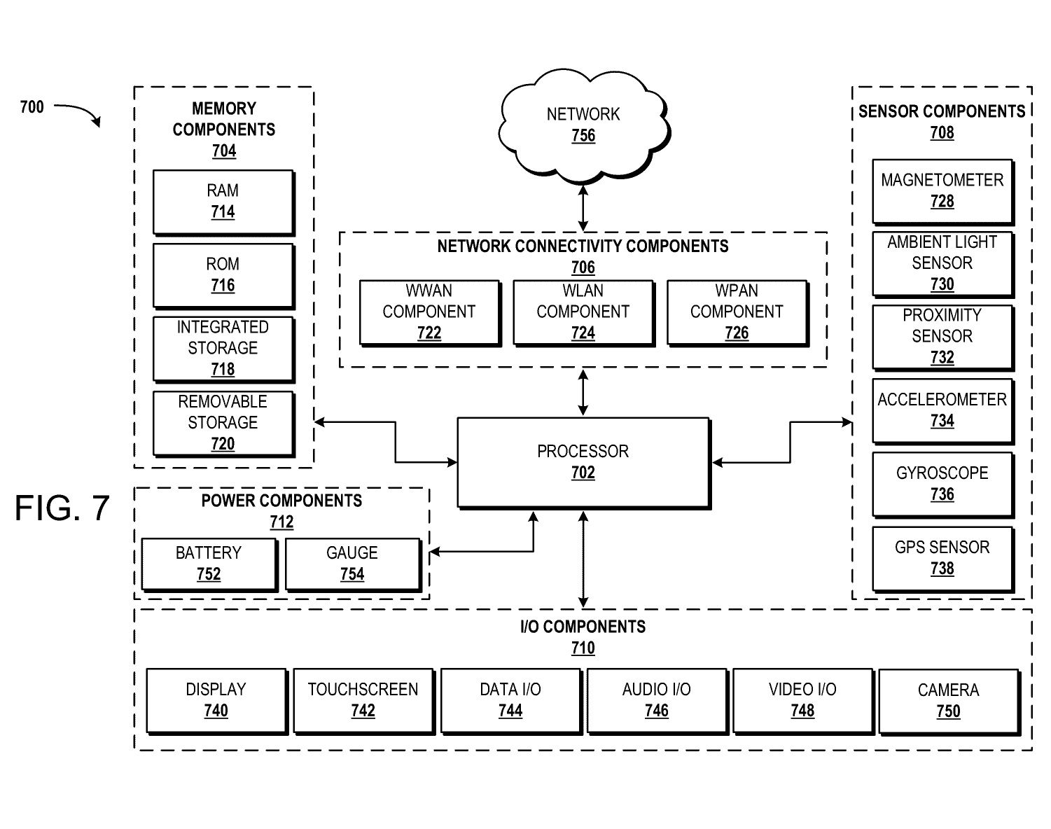

According to various implementations, the distributed computing environment 600 includes a computing environment 602 operating on, in communication with, or as part of the network 604. The network 604 may be or may include the network 756, described above with reference to FIG. 5. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In one illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing intelligent identification of multidimensional insights from process data. It should be understood that this configuration is illustrative, and should not be construed as being limiting in any way. The application servers 608 also host or provide access to one or more portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also may include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above configurations are illustrative, and should not be construed as being limited in any way. According to various implementations, the social networking services 622 may host one or more applications and/or software modules for providing the functionality described herein for providing intelligent identification of multidimensional insights from process data. For instance, any one of the application servers 608 may communicate or facilitate the functionality and features described herein. For instance, a social networking application, mail client, messaging client or a browser running on a phone or any other client 606 may communicate with a networking service 622 and facilitate the functionality, even in part, described above with respect to FIG. 4.

As shown in FIG. 6, the application servers 608 also can host other services, applications, portals, and/or other resources (“other resources”) 624. The other resources 624 can include, but are not limited to, document sharing, rendering or any other functionality. It thus can be appreciated that the computing environment 602 can provide integration of the concepts and technologies disclosed herein provided herein with various mailbox, messaging, social networking, and/or other services or resources.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data. Although not illustrated in FIG. 6, the datastores 626 also can host or store web page documents, word documents, presentation documents, data structures, algorithms for execution by a recommendation engine, and/or other data utilized by any application program or another module, such as the content manager 105. Aspects of the datastores 626 may be associated with a service for storing files.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 600 to utilize the functionality described herein for providing intelligent identification of multidimensional insights from process data, among other aspects. In one specific example, as summarized above, techniques described herein may be implemented, at least in part, by the web browser application 510 of FIG. 5, which works in conjunction with the application servers 608 of FIG. 6.

Turning now to FIG. 7, an illustrative computing device architecture 700 for a computing device that is capable of executing various software components described herein for providing intelligent identification of multidimensional insights from process data. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 700 is applicable to any of the clients 606 shown in FIG. 6. Moreover, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 604 of FIG. 6. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited, WI-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The magnetometer 728 is configured to measure the strength and direction of a magnetic field. In some configurations the magnetometer 728 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 728 are contemplated.

The ambient light sensor 730 is configured to measure ambient light. In some configurations, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some configurations, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some configurations, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some configurations, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some configurations, output from the gyroscope 736 is used by an application program as an input mechanism to control some functionality of the application program. For example, the gyroscope 736 can be used for accurate recognition of movement within a 3D environment of a video game application or some other application. In some configurations, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 740 is a liquid crystal display (“LCD”) utilizing any active or passive matrix technology and any backlighting technology (if used). In some configurations, the display 740 is an organic light emitting diode (“OLED”) display. Other display types are contemplated.

The touchscreen 742, also referred to herein as a “touch-enabled screen,” is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 742 is incorporated on top of the display 740 as a transparent layer to enable a user to use one or more touches to interact with objects or other information presented on the display 740. In other configurations, the touchscreen 742 is a touch pad incorporated on a surface of the computing device that does not include the display 740. For example, the computing device may have a touchscreen incorporated on top of the display 740 and a touch pad on a surface opposite the display 740.

In some configurations, the touchscreen 742 is a single-touch touchscreen. In other configurations, the touchscreen 742 is a multi-touch touchscreen. In some configurations, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application program.

In some configurations, the touchscreen 742 supports a tap gesture in which a user taps the touchscreen 742 once on an item presented on the display 740. The tap gesture may be used for various reasons including, but not limited to, opening or launching whatever the user taps. In some configurations, the touchscreen 742 supports a double tap gesture in which a user taps the touchscreen 742 twice on an item presented on the display 740. The double tap gesture may be used for various reasons including, but not limited to, zooming in or zooming out in stages. In some configurations, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some configurations, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some configurations, the touchscreen 742 supports a flick gesture in which a user swipes a finger in the direction the user wants the screen to move. The flick gesture may be used for various reasons including, but not limited to, scrolling horizontally or vertically through menus or pages. In some configurations, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a web site, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limiting in any way.

The data I/O interface component 744 is configured to facilitate input of data to the computing device and output of data from the computing device. In some configurations, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 746 is configured to provide audio input and/or output capabilities to the computing device. In some configurations, the audio I/O interface component 746 includes a microphone configured to collect audio signals. In some configurations, the audio I/O interface component 746 includes a headphone jack configured to provide connectivity for headphones or other external speakers. In some configurations, the audio I/O interface component 746 includes a speaker for the output of audio signals. In some configurations, the audio I/O interface component 746 includes an optical audio cable out.

The video I/O interface component 748 is configured to provide video input and/or output capabilities to the computing device. In some configurations, the video I/O interface component 748 includes a video connector configured to receive video as input from another device (e.g., a video media player such as a DVD or BLURAY player) or send video as output to another device (e.g., a monitor, a television, or some other external display). In some configurations, the video I/O interface component 748 includes a High-Definition Multimedia Interface (“HDMI”), mini-HDMI, micro-HDMI, DisplayPort, or proprietary connector to input/output video content. In some configurations, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some configurations, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some configurations, the battery gauge 754 is configured to measure the effect of a battery's discharge rate, temperature, age and other factors to predict remaining life within a certain percentage of error. In some configurations, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via an I/O component.

The disclosure presented herein may be considered in view of the following clauses.

Clause 1: A computer-implemented method, the method comprising: obtaining input data defining a plurality of attributes relating to individual stages of a multistage process; analyzing the plurality of attributes to identify one or more attributes of the plurality of attributes, wherein the one or more attributes are associated with a conversion rate of the multistage process exceeding a threshold level; and generating output data defining the one or more attributes.

Clause 2: The method of clause 1, further comprising causing a display of a representation of the multistage process, wherein the representation comprises a graphical element representing the one or more attributes, and wherein the graphical element is configured to indicate an association with at least one conversion of the multistage process.

Clause 3: The method of clauses 1-2, further comprising: causing a display of a representation of the multistage process, wherein the representation comprises a selectable graphical element associated with at least one conversion; obtaining a selection of the selectable graphical element; and causing a display of a first graphical element representing the one or more attributes, wherein the first graphical element is configured to indicate an association between the at least one conversion and the one or more attributes.

Clause 4: The method of clauses 1-3, wherein the output data associates the one or more attributes with data defining at least one conversion between stages of the multistage process.

Clause 5: The method of clauses 1-4, wherein the one or more attributes are identified by: selecting a combination of candidate attributes from the plurality of attributes; determining a value for the combination of candidate attributes, the value is based on at least one conversion rate of the multistage process; determining if the value exceeds the threshold level; and identifying the combination of candidate attributes as the one or more attributes if the value exceeds the threshold level.

Clause 6: The method of clauses 1-5, further comprising: determining a value indicating a size of a group associated with the one or more attributes; and causing a display of a graphical element representing the size of the group.

Clause 7: The method of clauses 1-6, further comprising: causing a display of a representation of at least a portion of the multistage process; and causing a display of a graphical element representing the one or more attributes, wherein a position of the graphical element is configured to indicate an association between the graphical element and a representation of the at least one conversion related to the one or more attributes.

Clause 8: A computing device, comprising: a processor; and a computer-readable storage medium in communication with the processor, the computer-readable storage medium having computer-executable instructions stored thereupon which, when executed by the processor, cause the computing device to obtain data defining a plurality of stages of a multistage process, obtain data defining a plurality of attributes associated with individual stages of the plurality of stages, identify a combination of attributes of the plurality of attributes, wherein the combination of attributes are associated with a conversion rate of the multistage process exceeding a threshold level, and generate output data defining the combination of attributes.

Clause 9: The computing device of clause 8, wherein the computer-readable storage medium comprises further instructions configured to cause a display of a representation of the multistage process, wherein the representation comprises a graphical element representing the combination of attributes, and wherein the graphical element is configured to indicate an association between the combination of attributes and at least one stage of the multistage process.

Clause 10: The apparatus of clauses 8-9, wherein the computer-readable storage medium comprises further instructions configured to: cause a display of a representation of the multistage process, wherein the representation comprises a selectable graphical element associated with at least one stage of the multistage process; obtain a selection of the selectable graphical element; and cause a display of a first graphical element representing the combination of attributes, wherein the first graphical element is configured to indicate an association between the combination of attributes and at least one stage of the multistage process.

Clause 11: The apparatus of clauses 8-10, wherein the output data is configured to associate the combination of attributes with data defining at least one stage.

Clause 12: The apparatus of clauses 8-11, wherein the combination of attributes are identified by: selecting a combination of candidate attributes from the plurality of attributes; determining a value for the combination of candidate attributes; determining if the value exceeds the threshold level; and identifying the combination of candidate attributes as the combination of attributes if the value exceeds the threshold level.

Clause 13: The apparatus of clauses 8-12, wherein the computer-readable storage medium comprises further instructions configured to: determine a value indicating a size of a group associated with the combination of attributes; and cause a display of a graphical element representing the size of the group.

Clause 14: The apparatus of clauses 8-13, wherein the computer-readable storage medium comprises further instructions configured to: cause a display of a representation of at least a portion of the multistage process; and cause a display of a graphical element representing the combination of attributes, wherein a position of the graphical element is configured to indicate an association between the graphical element and a representation of at least one stage of the multistage process.

Clause 15: A computer-readable storage medium having computer-executable instructions stored thereupon which, when executed by a computer, cause the computer to: obtain data defining a plurality of stages of a multistage process; obtain data defining a plurality of attributes associated with individual stages of the plurality of stages; identify a combination of attributes of the plurality of attributes, wherein the combination of attributes is associated with a conversion rate between at least two stages of the plurality of stages; and generate output data defining the combination of attributes.

Clause 16: The computer-readable storage medium of clause 15, wherein the computer-readable storage medium comprises further instructions configured to cause a display of a representation of the multistage process, wherein the representation comprises a graphical element representing the combination of attributes, and wherein the graphical element is configured to indicate an association between the combination of attributes and the at least two stages.

Clause 17: The computer-readable storage medium of clauses 15-16, wherein the computer-readable storage medium comprises further instructions configured to: cause a display of a representation of the multistage process, wherein the representation comprises a selectable graphical element associated with a conversion of the at least two stages; obtain a selection of the selectable graphical element; and cause a display of a graphical element representing the combination of attributes, wherein the graphical element is configured to indicate an association between the combination of attributes and the conversion of the at least two stages.

Clause 18: The computer-readable storage medium of clauses 15-17, wherein the combination of attributes are identified by: selecting a combination of candidate attributes from the plurality of attributes; determining a value for the combination of candidate attributes; determining if the value exceeds the threshold level; and identifying the combination of candidate attributes as the combination of attributes, if the value exceeds the threshold level.

Clause 19: The computer-readable storage medium of clauses 15-18, wherein the computer-readable storage medium comprises further instructions configured to: determine a value indicating a size of a group associated with the combination of attributes; and cause a display based, at least in part, on the output data, wherein the display includes a graphical element representing the size of the group.

Clause 20: The computer-readable storage medium of clauses 15-19, wherein the computer-readable storage medium comprises further instructions configured to: cause a display of a representation of at least a portion of the multistage process; and cause a display of a graphical element representing the combination of attributes, wherein a position of the graphical element is configured to indicate an association between the graphical element and a representation of a conversion of the at least two stages.

Based on the foregoing, it should be appreciated that concepts and technologies described herein provide intelligent identification of multidimensional insights from process data. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A computer-implemented method, the method comprising:
obtaining input data defining a plurality of attributes relating to individual stages of a multistage process;
analyzing the plurality of attributes to identify one or more attributes of the plurality of attributes, wherein the one or more attributes are associated with a conversion rate of the multistage process exceeding a threshold level; and
generating output data defining the one or more attributes.

2. The method of claim 1, further comprising causing a display of a representation of the multistage process, wherein the representation comprises a graphical element representing the one or more attributes, and wherein the graphical element is configured to indicate an association with at least one conversion of the multistage process.

3. The method of claim 1, further comprising:
causing a display of a representation of the multistage process, wherein the representation comprises a selectable graphical element associated with at least one conversion;
obtaining a selection of the selectable graphical element; and
causing a display of a first graphical element representing the one or more attributes, wherein the first graphical element is configured to indicate an association between the at least one conversion and the one or more attributes.

4. The method of claim 1, wherein the output data associates the one or more attributes with data defining at least one conversion between stages of the multistage process.

5. The method of claim 1, wherein the one or more attributes are identified by:
selecting a combination of candidate attributes from the plurality of attributes;
determining a value for the combination of candidate attributes, the value is based on at least one conversion rate of the multistage process;
determining if the value exceeds the threshold level; and
identifying the combination of candidate attributes as the one or more attributes if the value exceeds the threshold level.

6. The method of claim 1, further comprising:
determining a value indicating a size of a group associated with the one or more attributes; and
causing a display of a graphical element representing the size of the group.

7. The method of claim 1, further comprising:
causing a display of a representation of at least a portion of the multistage process; and
causing a display of a graphical element representing the one or more attributes, wherein a position of the graphical element is configured to indicate an association between the graphical element and a representation of the at least one conversion related to the one or more attributes.

8. A computing device, comprising:
a processor; and
a computer-readable storage medium in communication with the processor, the computer-readable storage medium having computer-executable instructions stored thereupon which, when executed by the processor, cause the computing device to
obtain data defining a plurality of stages of a multistage process,
obtain data defining a plurality of attributes associated with individual stages of the plurality of stages,
identify a combination of attributes of the plurality of attributes, wherein the combination of attributes are associated with a conversion rate of the multistage process exceeding a threshold level, and
generate output data defining the combination of attributes.

9. The computing device of claim 8, wherein the computer-readable storage medium comprises further instructions configured to cause a display of a representation of the multistage process, wherein the representation comprises a graphical element representing the combination of attributes, and wherein the graphical element is configured to indicate an association between the combination of attributes and at least one stage of the multistage process.

10. The computing device of claim 8, wherein the computer-readable storage medium comprises further instructions configured to:
cause a display of a representation of the multistage process, wherein the representation comprises a selectable graphical element associated with at least one stage of the multistage process;
obtain a selection of the selectable graphical element; and
cause a display of a first graphical element representing the combination of attributes, wherein the first graphical element is configured to indicate an association between the combination of attributes and at least one stage of the multistage process.

11. The computing device of claim 8, wherein the output data is configured to associate the combination of attributes with data defining at least one stage.

12. The computing device of claim 8, wherein the combination of attributes are identified by:
selecting a combination of candidate attributes from the plurality of attributes;
determining a value for the combination of candidate attributes;
determining if the value exceeds the threshold level; and
identifying the combination of candidate attributes as the combination of attributes if the value exceeds the threshold level.

13. The computing device of claim 8, wherein the computer-readable storage medium comprises further instructions configured to:
determine a value indicating a size of a group associated with the combination of attributes; and
cause a display of a graphical element representing the size of the group.

14. The computing device of claim 8, wherein the computer-readable storage medium comprises further instructions configured to:
cause a display of a representation of at least a portion of the multistage process; and
cause a display of a graphical element representing the combination of attributes, wherein a position of the graphical element is configured to indicate an association between the graphical element and a representation of at least one stage of the multistage process.

15. A computer-readable storage medium having computer-executable instructions stored thereupon which, when executed by a computer, cause the computer to:
obtain data defining a plurality of stages of a multistage process;
obtain data defining a plurality of attributes associated with individual stages of the plurality of stages;
identify a combination of attributes of the plurality of attributes, wherein the combination of attributes is associated with a conversion rate between at least two stages of the plurality of stages; and
generate output data defining the combination of attributes.

16. The computer-readable storage medium of claim 15, wherein the computer-readable storage medium comprises further instructions configured to cause a display of a representation of the multistage process, wherein the representation comprises a graphical element representing the combination of attributes, and wherein the graphical element is configured to indicate an association between the combination of attributes and the at least two stages.

17. The computer-readable storage medium of claim 15, wherein the computer-readable storage medium comprises further instructions configured to:
cause a display of a representation of the multistage process, wherein the representation comprises a selectable graphical element associated with a conversion of the at least two stages;
obtain a selection of the selectable graphical element; and
cause a display of a graphical element representing the combination of attributes, wherein the graphical element is configured to indicate an association between the combination of attributes and the conversion of the at least two stages.

18. The computer-readable storage medium of claim 15, wherein the combination of attributes are identified by:
selecting a combination of candidate attributes from the plurality of attributes;
determining a value for the combination of candidate attributes;
determining if the value exceeds the threshold level; and
identifying the combination of candidate attributes as the combination of attributes, if the value exceeds the threshold level.

19. The computer-readable storage medium of claim 15, wherein the computer-readable storage medium comprises further instructions configured to:
determine a value indicating a size of a group associated with the combination of attributes; and
cause a display based, at least in part, on the output data, wherein the display includes a graphical element representing the size of the group.

20. The computer-readable storage medium of claim 15, wherein the computer-readable storage medium comprises further instructions configured to:
cause a display of a representation of at least a portion of the multistage process; and
cause a display of a graphical element representing the combination of attributes, wherein a position of the graphical element is configured to indicate an association between the graphical element and a representation of a conversion of the at least two stages.
